(19) United States
(12) Patent Application Publication
(10) Pub. No.: US 2004/0208986 A1
(43) Pub. Date: Oct. 21, 2004

(54) Testing methods for silica containing films and layers

(76) Inventors: Bruce Wayne Flint, Columbia, MO (US); Robert L. Heimann, Centralia, MO (US); Nancy G. Heimann, Centralia, MO (US); Brian Patrick Skrabal, Columbia, MO (US); Wayne L. Soucie, Columbia, MO (US); Dennis Joseph Winn, Moberly, MO (US)

Correspondence Address: MICHAEL K. BOYER, ORSCHELN MANAGEMENT CO, 2000 US HWY 63 SOUTH, MOBERLY, MO, 65270, US

(21) Appl. No.: 10/799,814

(22) Filed: Mar. 12, 2004

Related U.S. Application Data
(60) Provisional application No. 60/454,861, filed on Mar. 13, 2003.

(51) Int. Cl. B32B 15/04

(52) U.S. Cl. 427/8

(57) ABSTRACT

The disclosure relates to methods for ascertaining the corrosion resistant effectiveness of a silica containing film or layer upon a metal surface. The disclosed methods employ colormetric as well as chemical leaching processes. The effectiveness of the silica containing film or layer is dependent upon the uniformity, lack of porosity, micro-cracks, among other potential defects in the silica containing film or layer that affect the ability of the film or layer to protect an underlying metal surface from corrosive environments.

This application claims benefit of Provisional Patent Application Serial No. 60/454,861, filed on Mar. 13, 2003. The disclosure of this provisional patent application is hereby incorporated by reference.

### CROSS REFERENCE TO RELATED PATENTS AND PATENT APPLICATIONS

The instant invention is related to the following commonly assigned patents and patent applications: U.S. Pat. Nos. 6,149,794; 6,258,243; 6,153,080; 6,322,687; 6,572,756B2 and U.S. patent application Ser. No. 09/775,072, filed on Feb. 1, 2001, Ser. No. 09/814,641, filed on Mar. 22, 2001 (corresponding to PCT/US01/09293), Ser. No. 10/211,051, filed on Aug. 2, 2002 (corresponding to PCT/US02/24716), Ser. No. 10/211,094, filed on Aug. 2, 2002 (corresponding to PCT/US02/24446), and Ser. No. 10/211,029, filed on Aug. 2, 2002 (corresponding to PCT/US02/24617); the entire disclosure of the foregoing is hereby incorporated by reference.

### FIELD OF THE INVENTION

The invention relates to analytical methods and related equipment for determining the effectiveness of a corrosion resistant silica containing film or layer.

### BACKGROUND OF THE INVENTION

Corrosion resistant coatings are known in the metal finishing art. Examples of such known coatings comprise chromates (hexavalent and trivalent), phosphates, heavy metals, among other coatings. These coatings, however, are environmentally undesirable. One environmentally desirable metal finishing process comprises exposing the metal to a silicate containing medium under conditions sufficient to form a silica containing film or layer. The silicate containing medium, its usage and products formed there from are described in greater detail in the patents and patent applications cross referenced below.

Conventional analytical methods comprise exposing a metal article to salt fog or spray for an extended period of time (e.g., ASTM B-117). There is a need in this art for a faster and more accurate analytical method for evaluating the effective corrosion resistant properties of the silica containing film or layer, especially for the purpose of research and development and production screening.

### SUMMARY OF THE INVENTION

The instant invention solves problems in this art by providing analytical methods for detecting the effectiveness of silica containing films or layers upon a metal surface. By “silica containing films or layers”, it is meant the surface formed in accordance with the disclosure of the patents and patent applications cross referenced below and coatings, films or layers comprising silica or at least one silicate. The silica containing film or layer can comprise an outer layer of silica upon a metal silicate that in turn overlies a metal surface. The silica containing film or layer imparts improved corrosion resistance, heat resistance, adhesion to paints/topcoatings, among other beneficial properties to the metal surface. The metal surface can comprise a wide range of metals such as at least one member selected from the group consisting of iron, steel, stainless steel, zinc, zinc alloys (e.g., zinc-nickel, zinc-iron, tin-zinc, among others), aluminum, aluminum alloys, nickel, titanium, among other metal surfaces.

In one aspect of the invention, a chemical or leaching method for ascertaining the effectiveness of the silica containing layer is utilized. In another aspect of the invention, a calorimetric method for ascertaining the effectiveness of the silica containing layer is utilized. By “effectiveness” it is meant to ascertain the degree of porosity, microcracks, among other potential defects in the silica containing film or layer that can affect the corrosion resistance of the metal surface.

In another aspect of the invention, a chemical or leaching method for ascertaining the effectiveness of the silica containing layer upon which at least one coating has been applied. Examples of such coatings comprise at least one member selected from the group consisting of epoxies (e.g., heat cured epoxy containing paints), acrylics, urethanes, latexes, polyesters, fluoropolymers, among other coatings.

### BRIEF DESCRIPTION OF THE DRAWINGS

FIG. 1a is a graphical representation of data generated with a first aspect of the invention reported as a zinc leaching rate, or Zn concentration as a function of time.

FIG. 1b is a graphical representation of zinc concentration as a function of coating drying times.

FIG. 1c is a graphical representation of zinc concentration as a function of coating thickness.

FIG. 1d is a graphical representation of zinc concentration as a function of coating porosity.

FIG. 1e is a correlation plot of zinc leaching to neutral salt spray.

FIG. 1f is a graphical representation of zinc leaching data when a topcoat or paint is applied.

FIG. 2 is an illustration of a test bracket that can be used in accordance with the inventive methods.

FIG. 3 is an illustration of a fixture for holding test piece (including that of FIG. 2) while conducting the inventive methods.

FIG. 4A through 4D are photographs of rivets treated in accordance with Example 6

FIG. 5A through 5C are photographs of rivets treated in accordance with Example 7

FIGS. 6A through 6J are photographs of rivets treated in accordance with Example 8.

### DETAILED DESCRIPTION

The instant invention relates to methods for ascertaining the corrosion resistant effectiveness of a silica containing film or layer upon a metal surface. The effectiveness of the silica containing film or layer is dependent upon the uniformity, lack of porosity, micro-cracks, among other potential defects in the silica containing film or layer that affect the ability of the film or layer to protect an underlying metal surface from corrosive environments. Such defects can allow corrosive agents (e.g., salt, oxygen, acidic aqueous solutions) to penetrate the silica containing surface and corrode the underlying metal surface.

In one aspect of the invention, a chemical method for ascertaining the effectiveness of the silica containing layer is utilized. This method comprises contacting (e.g., submersing) at least a portion of a metal surface with an overlying silica containing layer in an acid solution. Over a period of time, the acid penetrates the silica containing layer and reaches the metal below. The metal then dissolves and travels (e.g., leaches) through the silica containing layer into the acid solution. The inventive method may be performed by submersing the entire test piece, or by isolating a specific surface area on the test piece. The concentration of the leached metal in the acid solution is measured as a function of time. The relative concentration of metal in the acidic solution at a given time is inversely proportional to the relative efficacy of the silica containing film (i.e. decreasing concentrations of metal in the acid solution indicate increasing film quality). By employing the inventive process, the relative corrosion resisting quality of a silica containing film or layer overlying a metal surface can be ascertained in significantly less time than conventional salt spray techniques (e.g., ASTM B-117).

The acidic environment can comprise any suitable acid that can penetrate defects in the silica containing surface and dissolve the underlying metal without substantially affecting the silica containing layer. Examples of suitable acid solutions comprise nitric, hydrochloric, sulfuric, phosphoric, hydrobromic, iodic, among others. The acid is normally diluted in water (e.g., de-ionized water) to a concentration of about 0.1 to about 2.0 M. In one specific aspect, when the metal surface comprises zinc (e.g., zinc plate or galvanized), the effectiveness of a silica containing film can be evaluated with a nitric solution (e.g., about 1.0 M aqueous nitric acid solution).

The concentration of the leached metal as a function of time can be detected by any suitable equipment and attendant methods for using the equipment. An example of suitable equipment for detecting the concentration of leached metal comprises an atomic absorption device (e.g., Flame Atomic Absorption available from Perkin Elmer), graphite furnace atomic absorption, inductively coupled plasma, UV-vis spectrophotometry, among others.

The data collected by this invention may be evaluated in any suitable manner. Examples of suitable methods for evaluating the collected data from a silica coated zinc surface comprise at least one of the following:

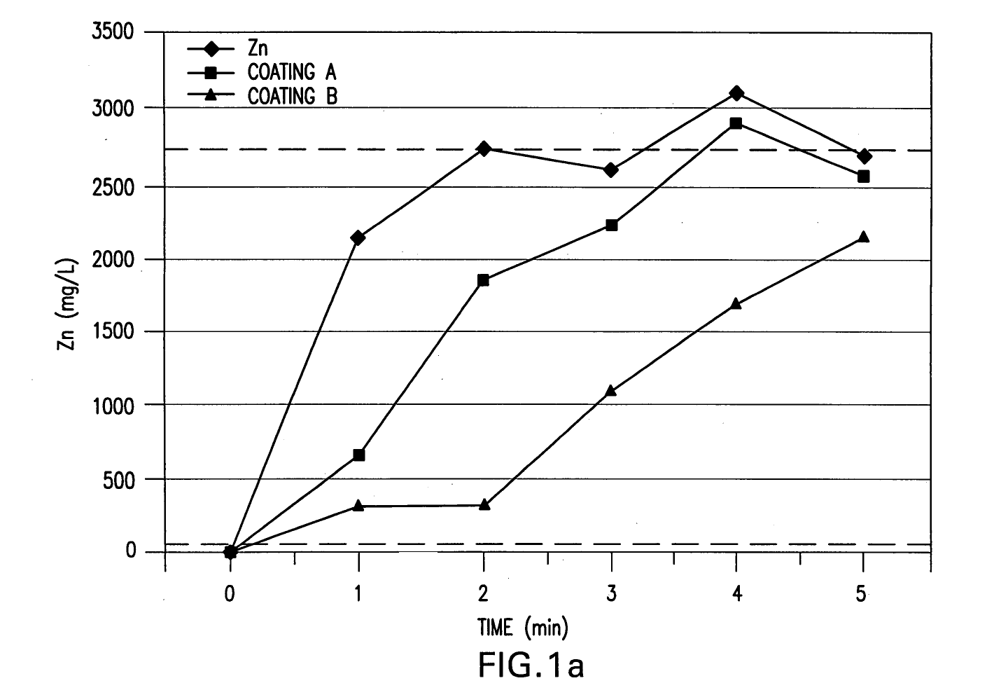

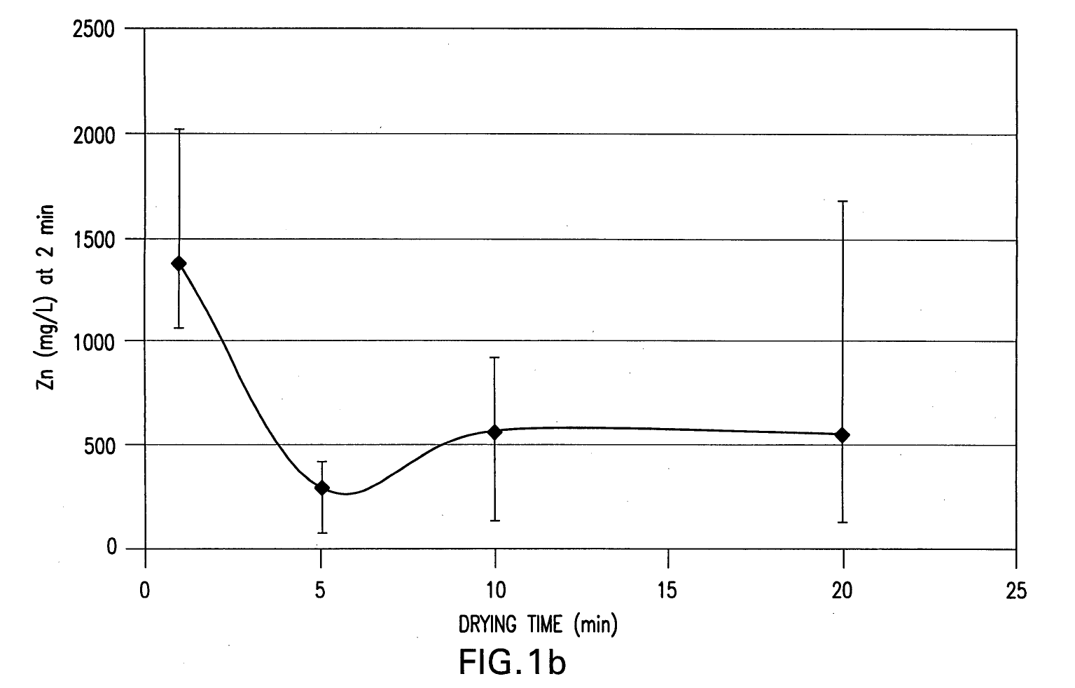

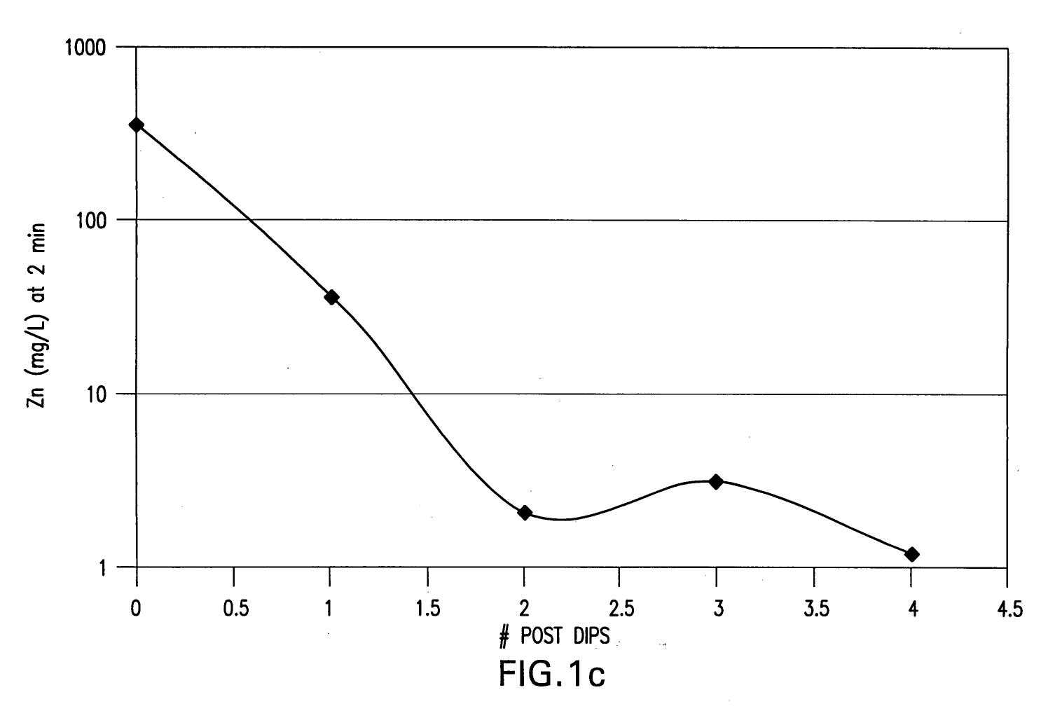

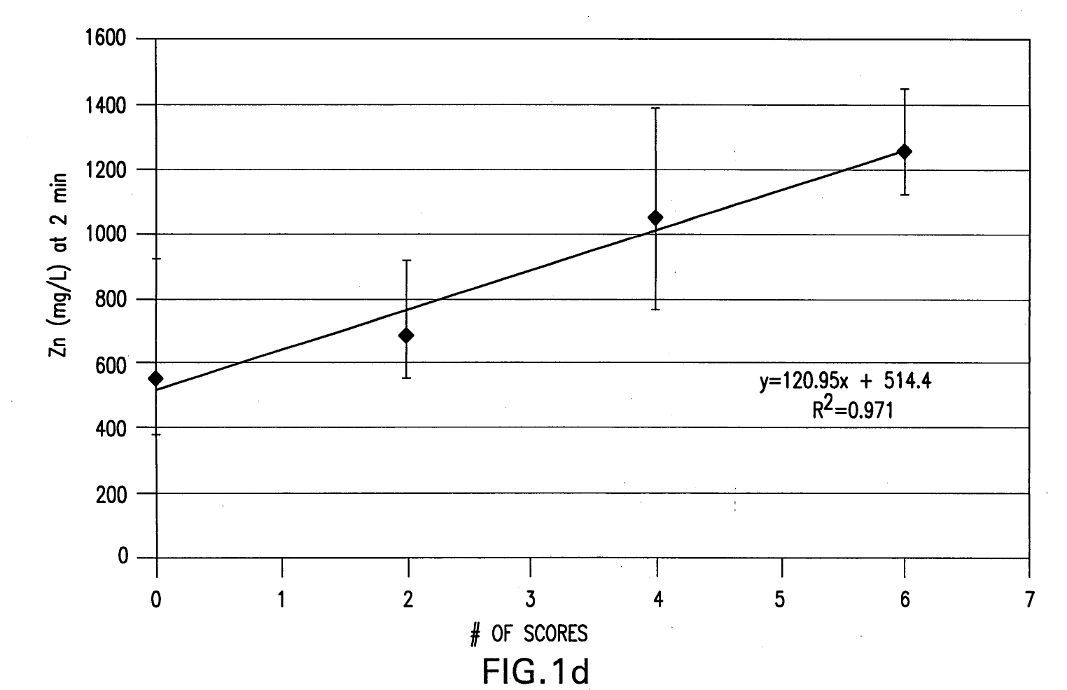

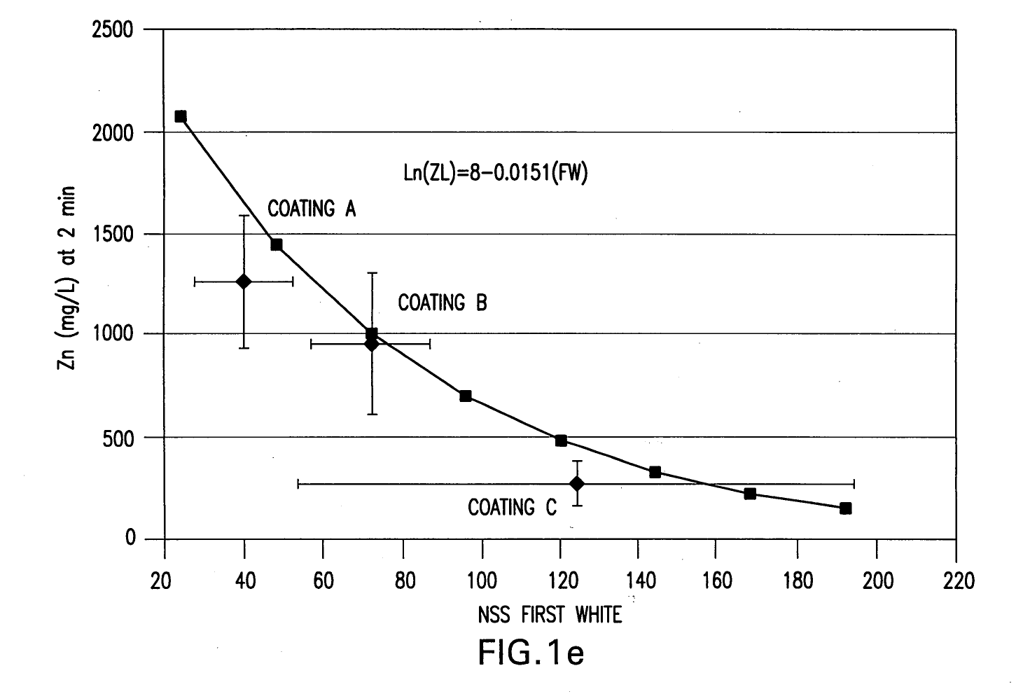

1) Zinc leaching rate as a function of time which is reported in [Zn]/min (zinc concentration per minute). Several time increments are measured in order to obtain a curve or slope representing the leaching rate (e.g., FIG. 1a described below in greater detail).

2) Percentage of zinc leached. The amount of zinc leached from a coated part is compared to the zinc leached from an uncoated part after a specific period of time and is reported as percentage of zinc leached (e.g., FIG. 1f).

3) Zinc concentration can be measured directly provided that acid concentration, surface area of part, acid volume, time and temperature are held constant for all samples (e.g., as illustrated in FIGS. 1b, 1c, 1d and 1e).

In another aspect of the invention, the relative effectiveness of a silica containing layer beneath a sealer, paint or topcoat may be ascertained. Paints and topcoats are thicker than the aforementioned silica containing layer and require more time in the acidic solution for the acid to penetrate both paint and silica containing layers. This aspect of the invention may be used to determine if a silica containing layer is present beneath the paint or topcoat, and/or whether the silica containing layer is sufficiently viable for adequate corrosion resistance.

In another aspect of the invention, the invention comprises a colorimetric method for ascertaining the effectiveness of the silica containing layer. The colorimetric method applies at least one compound upon the silica containing layer that can react with the metal in the underlying metal surface. If the silica containing film is not effective, then the applied compound penetrates the film and reacts with the metal surface wherein the reaction product has a pronounced color change. The color change should be sufficient to allow visual analysis and detection.

The colorimetric method can be employed as a dip, immersion or a drop test. Any suitable compound can be employed in the colorimetric method. Examples of such compounds comprise at least one member selected from the group consisting of soluble salts of copper and lead compounds such as copper sulphate, copper acetate, copper nitrate, lead acetate, lead nitrate, among others. When copper sulphate is employed and the underlying metal surface comprises zinc, the reaction product possesses a grey or black color. The intensity of the grey or black color is a function of the relative concentration of the reactants (e.g., the chemical reaction between copper sulphate and zinc can correspond to Zn+CuSO4------>ZnSO4+Cu wherein the copper metal product reacts with oxygen as 2Cu+O2------>a black 2CuO). Normally, the concentration of the applied colorimetric compound ranges from about 1.0 to about 20 g/mL.

The inventive methods can be employed as an in-process manufacturing quality test for determining the effectiveness of a corrosion resistant film or layer upon a metal surface. In particular, the inventive methods can be employed for ascertaining the effectiveness of silica containing films upon a zinc metal surface thereby avoiding the inconsistent results associated with conventional salt spray testing as well as reducing the time required to obtain data.

While the disclosure has emphasized using the inventive method for evaluating silica containing films, the inventive process can be used in connection with a wide range of organic or inorganic surfaces. That is, for evaluating films overlying a metal that can be dissolved or leached through the film.

The following Examples are provided to demonstrate certain aspects of the invention and do not limit the scope of the claims appended hereto. Modifications and alterations will occur to others upon reading and understanding this specification and following Examples. It is intended to include all such modifications and alterations insofar as they come within the scope of the appended claims or equivalents thereof.

### EXAMPLES

### Example 1

The Zinc Leaching (“ZL”) test of the Examples measures the rate at which zinc leaches through the silica containing film when submersed in a nitric acid solution. The acid solution will penetrate the coating and dissolve the zinc layer underneath, which then becomes part of the acid solution. The zinc concentration in the acid solution is then measured quantitatively by Atomic Absorption (AA) (e.g., Analyst 200 supplied by Perkin Elmer). The rate at which zinc leaches through the coating reflects the quality of the coating. Highly porous, cracked, or thin coatings, or coatings that are prone to dissolution will result in relatively high Zn leaching rates; the converse will result in low Zn leaching rates (i.e. the lower the Zn leaching rate, the better the coating). In FIG. 1a, the corrosion resistant quality of each group increases in the order of Zn<Coating A<Coating B<Coating C.

The data for FIG. 1a was collected using the following procedures.

Zn: Zn plated rivets only. The rivets measured about 0.75×1.0 inch. Total surface area of about 1.832 inches squared. No coating was applied.

Coating A: Zinc plated rivets were dipped in 10% PQ N-grade sodium silicate and dried at room temperature overnight.

Coating B was formed by the following process:

1) Zinc plated rivets were placed in a plating barrel and submersed in 10% PQ N-grade sodium silicate at 75° C. for 15 minutes while applying 12V, treating the work-pieces as the cathode.

2) The rivets were then removed and immediately dried in a heated K11 New Holland spin drier (temp approx 80-100° C.) for 5 minutes

3) Samples were removed and rinsed for 10 seconds in de-ionized water.

4) Samples were again dried with the same parameters as step 2.

The ZL procedure was performed as follows:

1) Prepared 1.0M HNO3—128.2 mL of 70% HNO3 diluted to 2.0 L

2) Completely submerse each individual rivet in a separate bath with approximately 30 mL of solution from item 1 for specified intervals (i.e., 1, 2, 3, 4, 5 minutes),

3) Transferred rivet to another beaker containing 30 mL of de-ionized water, completely submersing for three (3) seconds.

4) Remove rivet, discard.

5) Quantitatively transfer both solutions to a 100 mL volumetric flask and dilute to 100 mL by rinsing both beakers three (3) times with de-ionized water,

6) Mix thoroughly and transfer a portion to a small plastic bottle and perform elemental analysis on transferred portion by using an atomic absorption. Visual observations during the analysis were:

A) bubbles appeared on the rivet surface. Effervescence increases with time,

B) silica flakes were released from the rivet and rise to surface,

C) solution turned yellow with time as iron from below the zinc surface begins to dissolve.

### Example 2

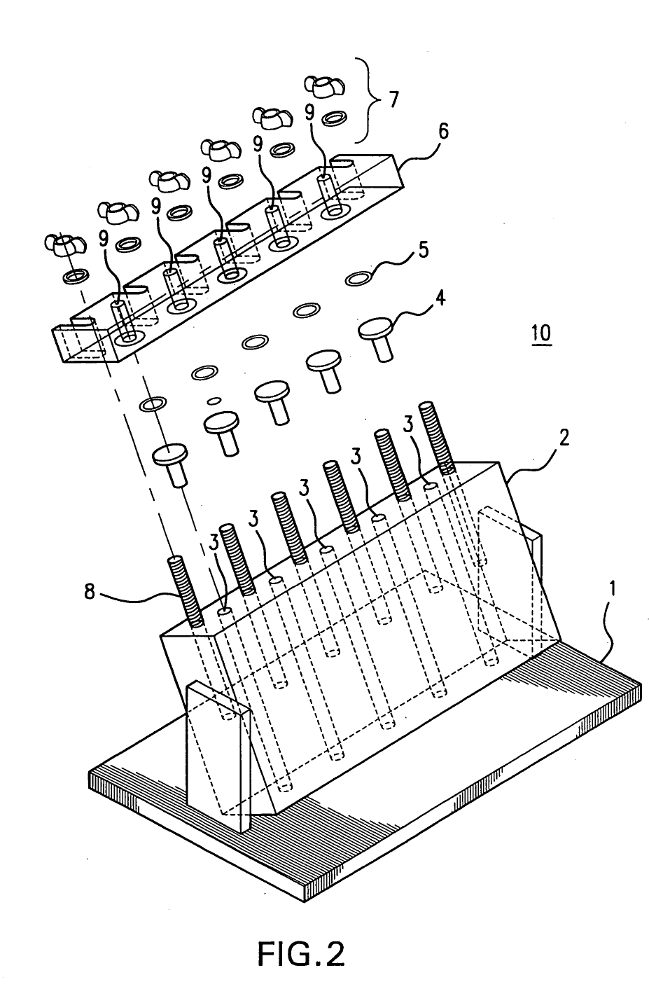

The ZL test may be performed by submersing the entire test piece (Example 1), or by isolating a specific surface area on the test piece. In the following example, a testing bracket was designed to isolate 0.815 cm squared of surface area on the heads of five rivets (i.e., FIG. 2 described below in greater detail). The ZL procedure for using the test bracket was as follows:

1) Place five rivets in test bracket (FIG. 2)

2) Prepared 1.0M HNO3-128.2 mL of 70% HNO3 diluted to 2.0 L.

3) Pipette 1 nL of solution from item 1 into each hollow space above the rivet surface on the test bracket.

4) Wait 2 minutes

5) Pipette each 1 mL solutions from item 3 into 5 separate 500 mL volumetric flasks and dilute with de-ionized water.

6) Five 15 mL bottles were filled with portions of diluted acid solutions from item 5. The remainder was discarded. The 15 mL portions are each approximately 0-5 ppm zinc.

7) Samples were tested on a Perkin Elmer AAnalyst 200a Flame AA spectrophotometer. The sample injection unit (nebulizer) was fitted with a “spacer” (included with the equipment) to extend the calibration range for Zn from 0-0.5 ppm to 0-5 ppm. The instrument was set to “Non-linear through zero” and calibrated with standard solutions of 0.5, 2, and 5 ppm Zn.

### Example 3

Sample groups of zinc plated rivets were treated in the following manner:

1) Zinc plated rivets were dipped in 10% PQ N-grade sodium silicate that was maintained at a temperature of 20° C., and then dried at 120° C. for increasing time intervals (1-20 minutes). The dried rivets were evaluated by measuring the zinc concentration in an acidic solution while holding acid concentration, acid volume, time and temperature constant. The solubility of the coating decreases with increased drying times. The data in FIG. 1b demonstrates that the inventive method can detect degrees of solubility in the silica containing coating.

2) The procedure from Example 1, Coating B was applied with the exception that steps 2-4 were repeated multiple times (post dips). The result was an increase coating thickness which was verified by using an SEM in a conventional manner. The data in FIG. 1c demonstrates that the inventive method can detect degrees of thickness in the silica containing layer.

3) The procedure from Example 1, Coating B was applied. The test pieces were then scratched with a tungsten-carbide scribe. Increasing numbers of scratches represent increasing coating porosity. The data in FIG. 1d demonstrates that the inventive method can detect degrees of coating porosity.

### Example 4

The inventive method also demonstrates a correlation to conventional Neutral Salt Spray (NSS) methods (i.e., ASTM B-117). Zinc plated rivet samples were treated with the following procedures:

Coating A: Same as Example 2, Coating B, with the exception that no electric current was applied in step 1, and the sodium silicate bath was at room temperature (20° C.).

Coating B: Same as Example 2, Coating B.

Coating C: Same as Example 2, Coating B, with the exception that no electric current was applied in step 1.

The data from this experiment was plotted in FIG. 1e. The correlation formula was calculated to be Ln(ZL)=8-0.0151(FW) where ZL is reported in Zn concentration and FW is the hours to first white in NSS. Vertical error bars represent the variability in ZL and horizontal error bars represent the variability in FW. The quality of the silica containing coatings increases in the order of Coating A<Coating B<Coating C.

### Example 5

The inventive method can be used to detect the relative corrosion resistant properties of a silica containing coating beneath a paint or topcoat. The data illustrated in FIG. 1f was generated from samples that were treated in the following manner and then painted:

Zn: No silica containing coating was applied

IR: A silica containing coating was applied without step 2 in the Example 1, Coating B procedure.

EMC: Example 1, Coating B procedure was applied

HD: Example 3, Coating C procedure was applied

FIG. 1f is a JMP™ software plot (by SAS Institute). It is a Fit Y by X analysis of multiple sampling groups. The dots represent each test piece and the diamonds represent the mean ZL values of each group. The ZL values are represented in % Zn leached. The circles on the right represent the ability of the inventive method to distinguish between groups (i.e. separated circle show that results from one group can be clearly distinguished from another.) EMC and HD show similar performance, while Zn controls and IR coatings are clearly distinguishable from the other application methods. This example demonstrates that the inventive method can be used to evaluate the relative corrosion resistant properties of a silica containing layer that was beneath a paint or topcoat.

Referring now to FIG. 2, which illustrates a sample or rivet holder (i.e., test fixture) that can be employed in connection with the instant examples. FIG. 2 illustrates that the test fixture retains the samples at a predetermined location while permitting exposure to chemistry associated with the inventive methods. The dimensions of the text fixture can be varied to accommodate a wide range of sample sizes. The test fixture 10 comprises a base 1 affixed to a sample block 2 that defines openings 3 that are dimensioned for receiving the test samples 4. Once the test samples 4 have been located within openings 3, an O-ring 5 is placed upon the test sample 4. A second block 6 is placed upon the O-ring 5 and secured in place by tightening wing nuts/washers 6 on threaded rods 8. Second block 6 defines cavities or wells 9 that allow the test sample 4 to be exposed to the aforementioned acidic solutions and in turn operation of the inventive method (e.g., by removal and testing of the solution from cavity 9).

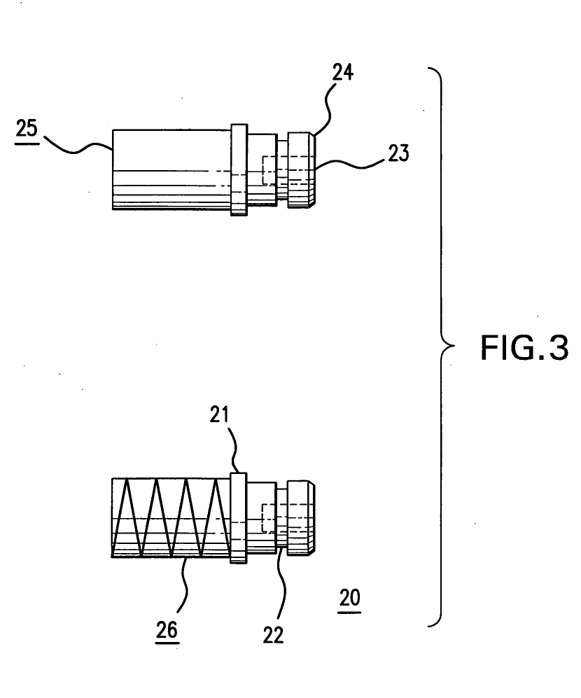

While Examples 1-5 employed the inventive method for evaluating zinc plated rivets, the inventive method can be used to test a wide range of configurations. Referring now to FIG. 3, FIG. 3 illustrates the configuration of a test piece that can be employed with the inventive methods and in the test fixture of FIG. 2. The illustrated test piece employs a wide range of features in order to permit evaluation of the silica containing film upon such features. This test piece can be added to other articles that are being treated to form the silica containing film. After treatment, the test piece is separated from the other articles and evaluated in accordance with the inventive methods. This evaluation provides an indication as to whether the other articles have an effective silica containing film. FIG. 3 illustrates a generally cylindrical test fixture 20. Test fixture 20 defines a ring like protuberance 21, and a groove or channel 22 around the fixture 20 and perpendicular to the longitudinal axis of fixture 20. Fixture 20 also defines an opening 23 that is adjacent to a beveled or chamfered region 24. Normally opening 23 will not extend throughout the length of fixture 20 so that a relatively flat surface 25 is available for testing. If desired, fixture 20 can include a threaded region 26.

### Example 6

This example illustrates performing the inventive calorimetric test as an in-process quality test for presence of an effective silica containing coating on zinc plated parts treated in accordance with aforementioned U.S. patent application Ser. No. 10/211,094, filed Aug. 2, 2002 (corresponding to PCT/US02/24446). Zinc electroplated rivets coated in accordance with the aforementioned silica containing film forming process were evaluated by exposure to small drops of copper sulphate having a concentration of 20 mg/mL. A zinc-plated rivet without a silica containing coating was also exposed as a control. The experiment was conducted in the following manner:

1. Two rivets were sampled from the silica film forming process by drying at a temperature of greater than 55 C in a New Holland K90 spin dryer for about 6 minutes then rinsed with de-ionized water, then dried again in the same device and at 55 C for about 11 minutes,

2. A single zinc plated rivet was placed alongside to act as an untreated control.

3. A pipette was used to deposit a small drop onto the surface of each rivet head as quickly as possible to keep the starting time for observations uniform for the four test pieces.

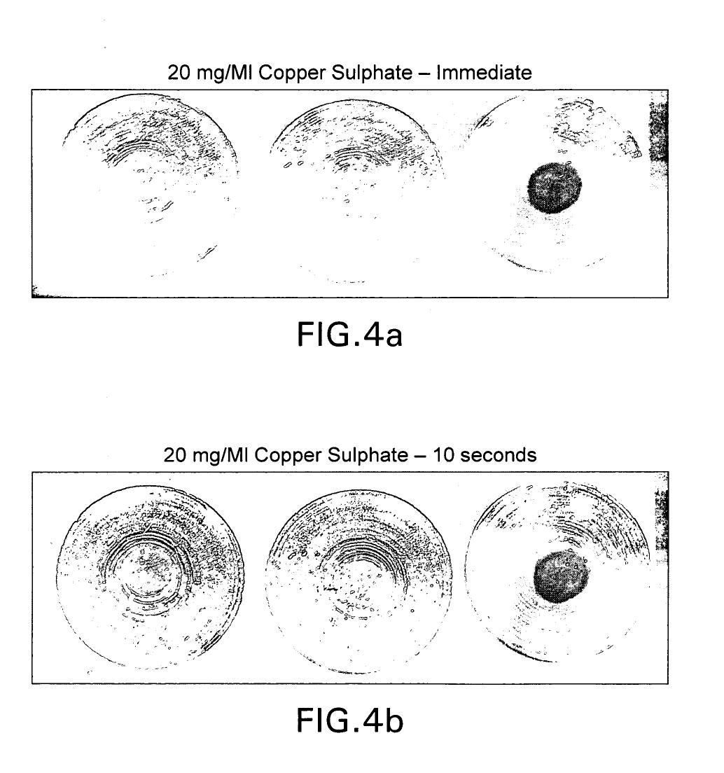

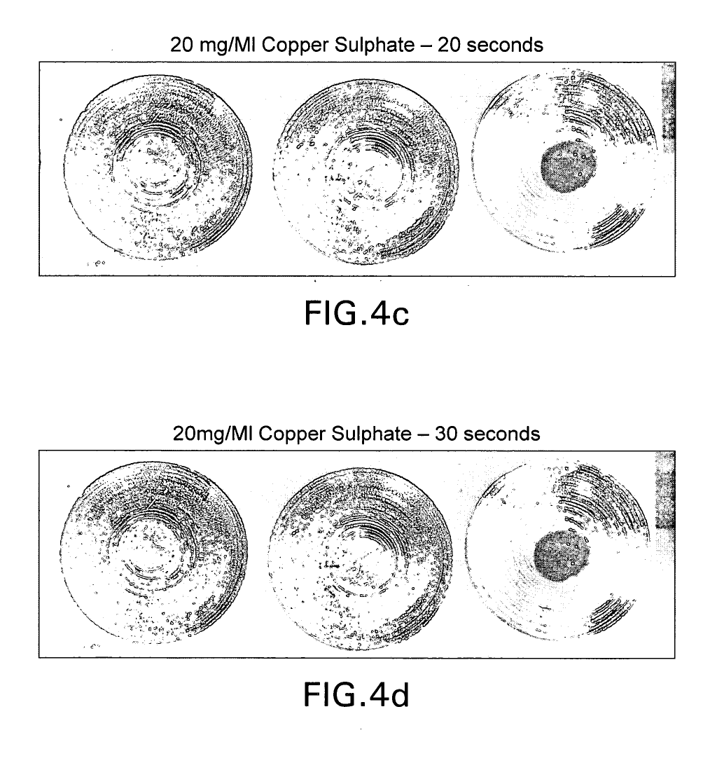

4. Photographs were taken at time intervals of immediately (1-2 seconds), 10 seconds, 20 seconds, and 30 seconds. The two rivets on the left were processed to possess a silica containing film, and the rivet on the right is the zinc control. The absence of any darkening on two of the rivet indicates a film that prohibits the zinc reaction. FIGS. 4A through 4D are photographs of rivets treated in accordance with this Example.

### Example 7

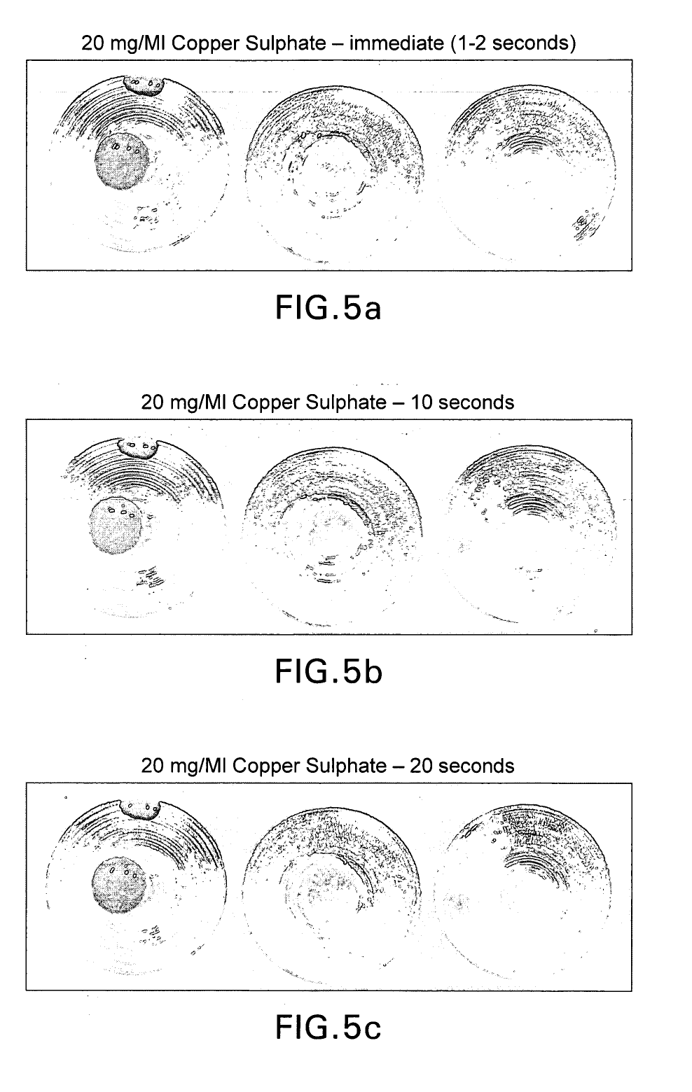

The same procedure of Example 6 was followed to obtain rivets having the silica containing film which was followed with an immediate rinse, then a dry cycle (i.e., in contrast to Example 6 wherein the rivets were dried and then rinsed). The evidence of graying on these parts over the time period of observation indicates a film that has flaws/pores/or thinness that allows the reaction of the test solution with the underlying zinc plate. In this example the zinc control piece is on the left and the two treated parts are on the right. FIGS. 5A through 5C are photographs of rivets treated in accordance with this Example.

### Example 8

This example demonstrates the affect of test solution concentration on the ability of the inventive colorimetric method to measure the effectiveness of the silica containing film and detect zinc and zinc films.

Zinc plated rivets treated in accordance with the silica containining film forming process of U.S. patent application Ser. No. 10/211,094, filed Aug. 2, 2002 (corresponding to PCT/US02/24446) were exposed to small drops of copper sulphate of a concentrations of 1 mg/Ml, 10 mg/Ml of 20 mg/Ml. Uncoated zinc-plated rivets were exposed as a control. The experiment was conducted in the following manner:

1. Six rivets were sampled from the silica film forming process were then dried at a temperature of greater than 55 C in a New Holland K90 spin dryer for about 6 minutes, then rinsed with de-ionized water, then dried again in the same spin dryer at about 55 C for about 11 minutes,

2. Six additional rivets were samples from the film forming process described in Example 3 herein 3. The rivets were placed in holder designed to hold the part surface parallel to the remaining samples in the group.

4. Zinc plated rivets (2-4 pieces) were placed alongside to act as untreated controls.

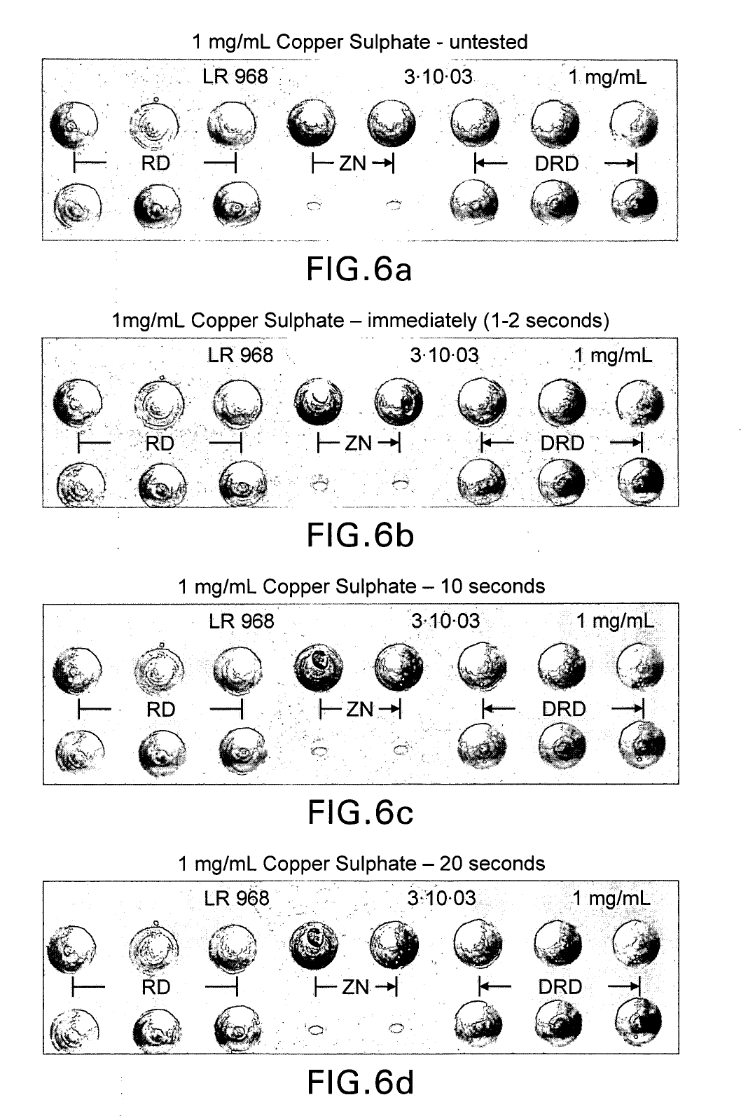

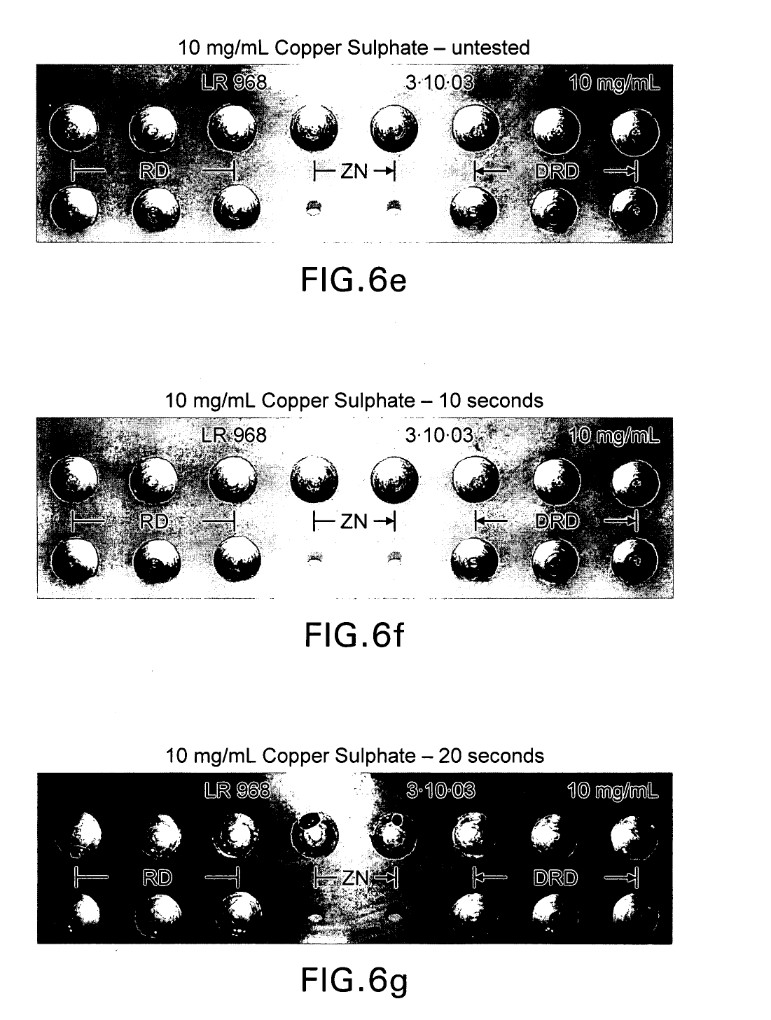

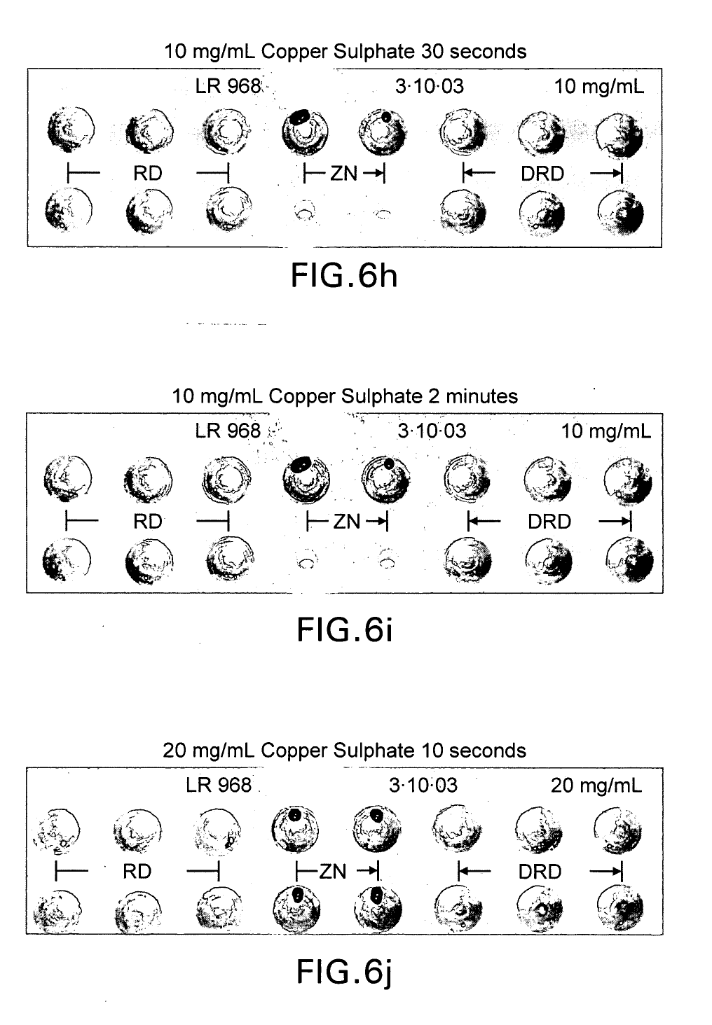

5. A pipet was used to deposit a small drop onto the surface of each rivet head as quickly as possible to keep the starting time for observations uniform for the four test pieces. Photographs were taken at time intervals of prior to test (untested), immediately (1-2 seconds), 10 seconds, 20 seconds, and 30 seconds, and additionally at 2 minutes for the lower two concentrations. The images are marked in the images with DRD (dry-rinse-dry) for samples from step 1, RD (rinse-dry) for samples from step 2, and zinc for samples from step 3 above. The absence of any darkening on a given rivet indicates the presence of a silica containing film that prohibits the zinc reaction. FIGS. 6A through 6J are photographs of rivets treated in accordance with this Example.

While the apparatus, compositions and methods of this invention have been described in terms of certain aspects or embodiments, it will be apparent to those of skill in the art that variations may be applied to the process described herein without departing from the concept and scope of the invention. All such similar equivalents, substitutes and modifications apparent to those skilled in the art are deemed to be within the scope and concept of the invention as defined by the appended claims.

The following is claimed:

1) A method for evaluating a coating upon a metal surface comprising:
forming a silica containing film or layer upon an electrically conductive surface,
exposing the silica containing film or layer to a solution that interacts with the silica containing film or layer, and;
determining the effectiveness of the silica containing film or layer.

2) A method for testing the effectiveness of a silica containing coating or film comprising:
providing a silica containing film or layer on a metallic surface, contacting at least a portion of the silica containing layer with an acidic source wherein at least a portion of the metallic surface is dissolved by the acidic source,
measuring the concentration of metal in the acidic source.

3) An analytical process comprising:
exposing a silica containing film or layer overlying a metal surface to an acidic medium,
detecting metal from the metal surface in the acidic medium, and;
ascertaining the effectiveness of the silica containing film or layer based upon the metal detected in the acidic medium.

4) The process of claim 3 wherein the metal surface comprises at least one member selected from the group consisting of iron, steel, stainless steel, zinc, zinc alloys, aluminum, aluminum alloys, nickel and titanium.

5) The process of claim 4 wherein the metal surface comprises zinc or zinc alloys.

6) The process of claim 3 wherein the acidic solution comprises water and at least one acid selected from the group consisting of nitric, hydrochloric, sulfuric, phosphoric, hydrobromic and iodic.

7) The process of claim 6 wherein the acid comprises nitric acid.

8) The process of claim 6 wherein at least one coating overlies the silica containing coating or film.

9) The process of claim 8 wherein the coating comprises at least one member selected from the group consisting of epoxies, silanes, latexes, urethanes, acrylics and polyesters.

10) The process of claim 8 wherein the coating comprises at least one epoxy.

11) The process of claim 1 wherein the solution comprises copper sulphate.

12) The process of claim 3 wherein the metal surface is held within a testing apparatus that retains the metal surface in a predetermined location and permits fluid contact between the metal surface and the acidic medium.

13) The process of claim 3 wherein the metal surface comprises a test fixture having at least one of the following features: threads, flat surface, openings and grooves.

14) The process of claim 3 wherein said detecting comprises measuring the concentration of metal by using atomic absorption.
